(19) United States
(12) Patent Application Publication
(10) Pub. No.: US 2015/0332092 A1
(43) Pub. Date: Nov. 19, 2015

(54) ACTION CONTROL APPARATUS

(71) Applicant: CDS WORLDWIDE PTY LTD, South Melbourne VIC (AU)

(72) Inventor: Michael Eli Silberberg, South Melbourne VIC (AU)

(21) Appl. No.: 14/715,543

(22) Filed: May 18, 2015

(30) Foreign Application Priority Data
May 16, 2014 (AU) 2014901822
May 22, 2014 (AU) 2014901919

(51) Int. Cl. G06K 9/00

(52) U.S. Cl. CPC G06K 9/00604; G06K 9/00617; G06K 9/00771; G06K 9/00845

(57) ABSTRACT

An action control apparatus comprises an iris scanner comprising an image capture device mounted to a movement mechanism, a movement controller arranged to monitor an area proximate the image capture device in order to detect at least one object associated with an expected position of an iris to be scanned, and upon detection of the at least one object, control the movement mechanism based on a position of the at least one object to move the image capture device along the at least one axis to a scanning position where the iris scanner can scan the iris, and an action controller arranged to determine whether to cause an action to occur based on a comparison of the scan of the iris with a database containing data of one or more approved irises.

### BACKGROUND OF THE INVENTION

The invention relates to an action control apparatus, which, in one application, is used to control entry to a car park.

The entry gate of current car parking installations usually has a card reader for reading a card assigned to a permanent user of the car park and a ticket printer for printing a ticket for a casual user in response to a user pressing a button. A successful read of a card of a permanent user or the printing of a ticket will cause the entry barrier to open to allow the user to enter the car park.

One or more intercom devices are also usually provided at the entrance to allow a user to speak to a car park attendant located on site in order to obtain assistance. In this respect, it is common for permanent user's of the car park to forget their card and need to contact the car park attendant to obtain access. This can lead to delays and a build-up of traffic behind the user's vehicle inconveniencing the user and the drivers of other vehicles.

At the exit, there is also provided a card reader for reading permanent cards and a ticket reader for reading tickets to determine whether they have been validated. Upon presentation of a valid ticket or a permanent card, the exit gate is opened allowing for egress of the user's vehicle. Again, at the exit, there is need to provide an intercom for users requiring assistance. Similar considerations can apply at the exit as at the entrance when a permanent user does not have their card.

With the above traditional parking systems in mind, there is a need for alternative types of controlling actions, such as controlling the entry to a car park.

### SUMMARY OF THE INVENTION

In an aspect, the invention provides an action control apparatus comprising:

an iris scanner comprising an image capture device mounted to a movement mechanism controllable to move the image capture device along at least one axis;

a movement controller arranged to monitor an area proximate the image capture device in order to detect at least one object associated with an expected position of an iris to be scanned, and upon detection of the at least one object, control the movement mechanism based on a position of the at least one object to move the image capture device along the at least one axis to a scanning position where the iris scanner can scan the iris;

an iris scanner controller arranged to control the iris scanner to obtain a scan of the iris when the iris scanner is in the scanning position; and

an action controller arranged to determine whether to cause an action to occur based on a comparison of the scan of the iris with a database containing data of one or more approved irises.

In an embodiment, the action controller is associated with a car park and the action is to cause a car park barrier to open.

In an embodiment, the object is a vehicle window.

In an embodiment, the object is a head.

In an embodiment, the object is a face.

In an embodiment, the object is an eye.

In an embodiment, the iris scanner is mounted to a movement mechanism for substantially vertical movement.

In an embodiment, the iris scanner is mounted for movement along two or more axes.

In an embodiment, movement is constrained within a defined region to prevent the iris scanner from contacting a vehicle.

### BRIEF DESCRIPTION OF THE DRAWINGS

An embodiment of the invention will now be described in relation to the accompanying drawings in which:

FIG. 1 illustrates the layout of a car park entrance in accordance with an embodiment of the invention;

FIGS. 2A and 2B show an example of an image capture device of an embodiment in first and second positions;

FIG. 3 is a block diagram of the car parking apparatus of an embodiment; and

FIG. 4 is an example of an action control apparatus.

### DETAILED DESCRIPTION

The action control apparatus of the invention may be used to control a number of different actions but is described in the drawings in relation to an embodiment where the action control apparatus is a car parking apparatus 300 and the action is to control a barrier to entry to, or exit from, a car park. Accordingly, referring to the drawings there is shown a car parking apparatus 300 which is arranged to permit a new type of entry to, and exit from a car park, where a user's iris is used as a form of identification and is read by the car parking apparatus in order to determine whether to allow entry into the car park.

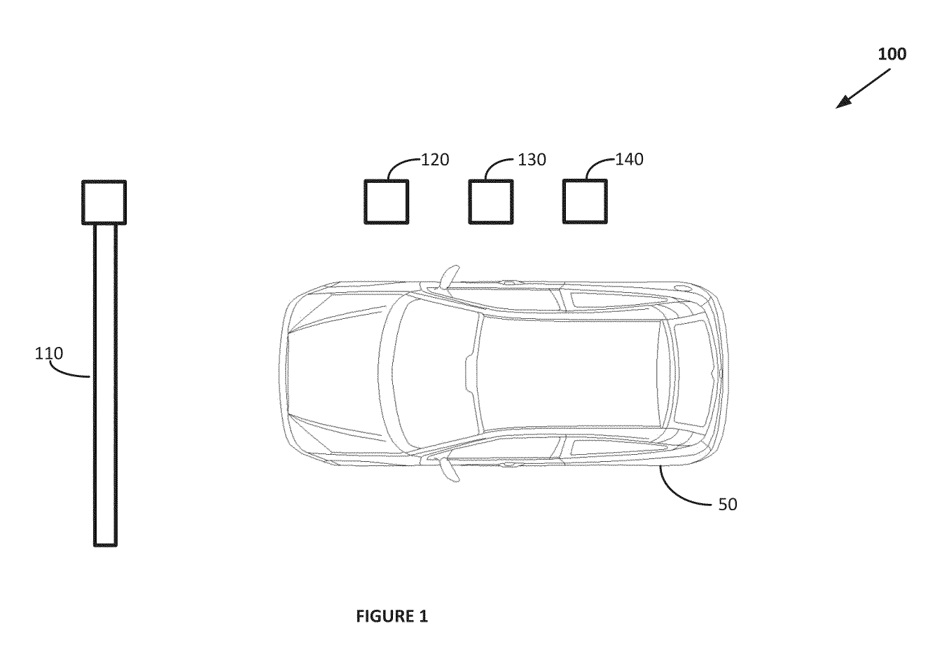

As shown in FIG. 1, an entry or an exit to a car park comprises an entry barrier in the form of a boom gate 110 for preventing a vehicle from entering. Spaced from the barrier are a conventional car reader 120 and a ticket issuer 140. Additionally, in accordance with the embodiment, there is provided an iris scanning unit 130.

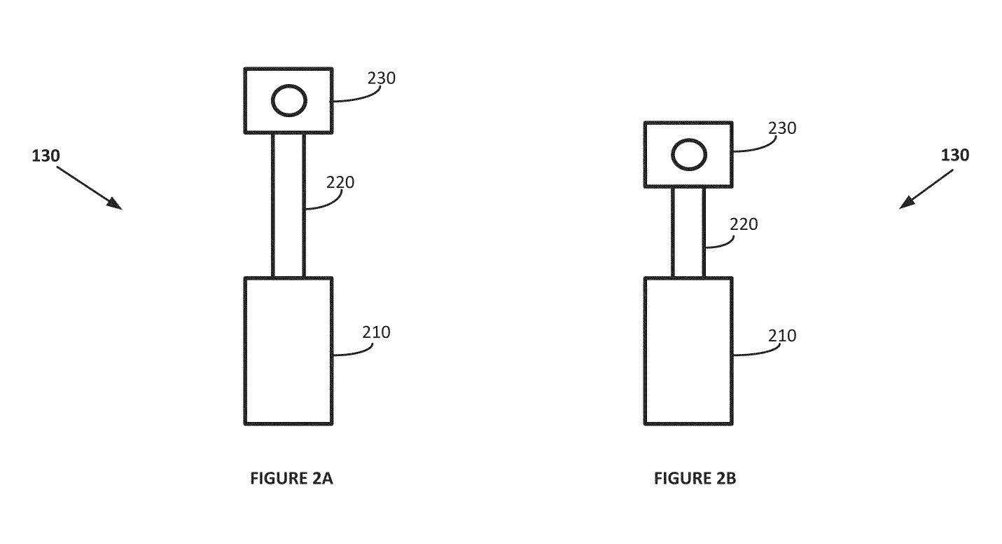

As shown in FIGS. 2A and 2B, the scanning unit 130 comprises an image capture device in the form of a charge coupled device based digital camera 230 mounted to a telescopically moveable mount 220, which is itself mounted to casing 210. In the embodiment casing 210 contains the other components of the apparatus including the processing electronics 310 and the drive mechanism 350 for moving the mount. In the embodiment, the telescopically moveable mount is a hydraulically operated. In other embodiments, it may be pneumatically operated. In further embodiments, other arrangements may be used to move the camera. In the embodiments, the camera 230 only moves along a substantially vertical axis. This prevents the camera from entering into an area where it may impede or accidentally touch a vehicle. In other embodiments, the camera is mounted on a robotic arm with two or more degrees of freedom. In such embodiments, the robotic arm is controlled by processing electronic to only move within a defined region to prevent it from impacting a vehicle.

As shown, in FIGS. 2A and 2B, the camera 230 has a range of movement between a first position (see FIG. 2A) and a second position (see FIG. 2B) in order to accommodate different driver positions caused by the relative height of different vehicles and drivers.

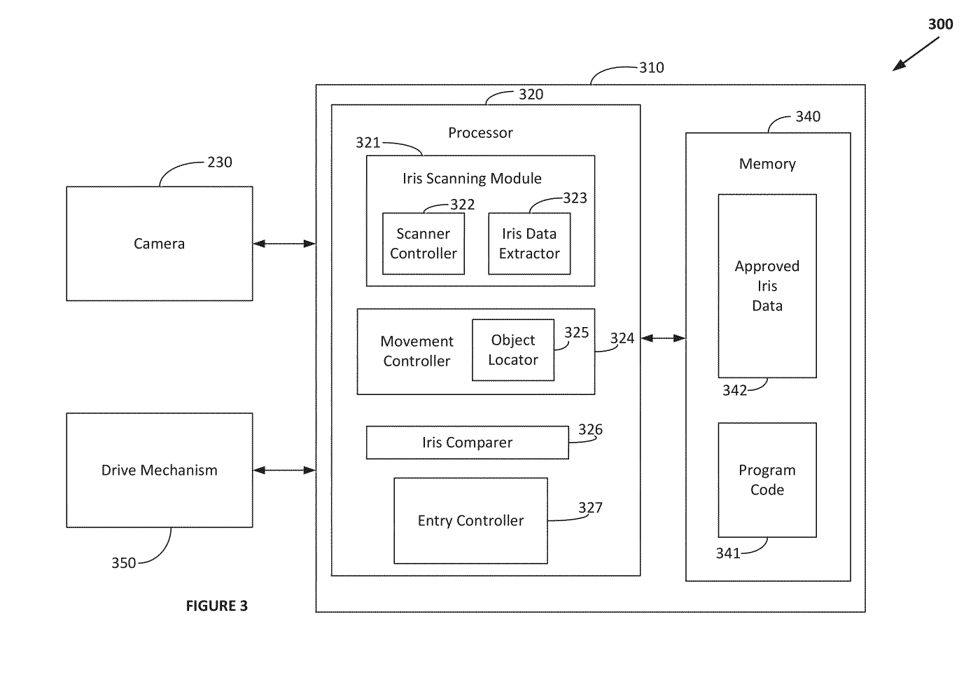

In this respect, referring to FIG. 3, when a vehicle is in position, the camera initially captures an image of the scene. Object locator 325 of movement controller 324 implemented by processor 320 of processing electronics 310 executing program code 341 stored in memory 340 processes the captured image to locate an object of interest within the scene. The object of interest may be a face or head or eye of a driver. In another embodiment, the object is a driver's window. Once the object is located, the movement controller 324 determines a desired position of the camera at which the controller judges that the iris of the driver can be scanned. The movement controller 324 then applies a movement by causing drive mechanism 350 to move the telescopic mount 220 to the desired position. Accordingly, it will be appreciated that the drive mechanism 350 and mount 220 provide a movement mechanism for moving the camera 230 to a desired scanning position. In some embodiments, the position may be periodically recalculated in order to refine the desired scanning position as the camera is moved into position.

In embodiments of the invention, a different camera is used to capture images of the screen than the one used for iris scanning, for example, a camera with a wider field of view is used to locate the position of the object. For example in one embodiment, the camera could be a web camera arranged to locate the driver's eye, via facial recognition software. In some embodiments, the iris scanner may be a self-contained unit, having a mirror behind which the iris capturing lenses are located. In one embodiment, the additional camera can be positioned above the mirror of the iris scanner. In some embodiments, the processing of the iris to generate iris data may be performed by the self-contained unit.

In a further embodiment, a multi-stage detection process may be used. For example, the first stage may be to identify the position of the driver's window and used to control initial movement of the camera 230 before a face is detected and the position of the camera 230 can be refined by further movement based on the position of the face determined by object locator 325.

Once the camera 230 is in a desired scanning position, iris scanning controller of iris scanning module 321 controls camera 230 to obtain the desired data of the driver's iris. In this respect, in one embodiment, the camera 230 uses both visible and near-infrared light to take a clear, high-contrast picture of a person's iris. With near-infrared light, a person's pupil is very black, making it easy for the computer to isolate the pupil and iris.

In one embodiment, the camera 230 focuses automatically on the user. When the camera takes a picture, in one embodiment, the scanning module 321 can locate the centre of the pupil, the edge of the pupil, the edge of the iris, the eyelids and eyelashes. Scanner controller 322 controls this process to ensure an adequate image is captured. An iris data extractor 323 then analyses the patterns in the iris and translates them into a code. This code is then be compared with approved iris data 342 stored in memory 342 by iris comparer 326. If the code matches pre-registered approved iris data 342, iris comparer 326 outputs a control signal to cause a entry controller 327 to cause the entry to open. Entry controller 327 may interface directly with boom gate 110 or with another system that controls the boom gate. If the iris data does not match a approved iris data, the boom gate remains lowered and the driver must take alternative action to enter, such as taking a ticket.

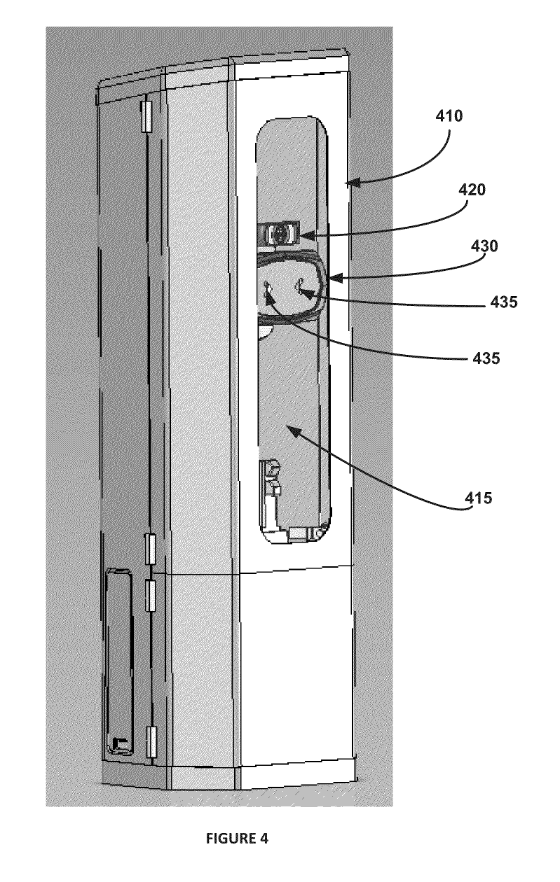

FIG. 4 shows an example of an action control apparatus 400 suitable for deployment at a car park entrance or exit. Action control apparatus 400 has a housing 410 having a glass window 415. A camera 420 and an iris scanner 430 are mounted within housing 410 behind window 415. The camera 420 is mounted above iris scanner 430. The camera 420 and iris scanner 430 are mounted to a linear actuator driven by an electric motor. In the example of FIG. 4, the linear actuator has a range of vertical movement of one metre in order to position the iris scanner 430. The iris scanner 430 has a range of up to three quarter of a metre to a metre. The iris scanner 430 has LED lights 435 that light green when a user's iris is captured and red when a capture fails in order to provide feedback to a user. The apparatus 400 enables hands-free validation of a registered user's iris.

In an alternative embodiment, the database may be stored on a server. In such an embodiment the entry control apparatus 300 may have, for example, a Wi-Fi card for communicating wirelessly with a wireless network in order to complete a connection via the internet with a host system that stores the iris data.

In some embodiments, the scanning unit 130 may incorporate a display. The display may be used to provide feedback to a user to assist in the scanning of the iris. For example, by showing the driver an image of their face taken by the camera and asking the driver to look at the centre of the display. The display can also provide feedback as to whether the driver's iris has been validated.

As indicated above, the action control apparatus may be used in a number of applications where obtaining an image of the user's iris and validating it against a database can be used to control an action.

In one example, the apparatus could be mounted near a door and used to control the action of opening or unlocking the door based on validation of the user's apparatus.

In another example, the apparatus could be used in a vending application or in other situations where there is need to make a payment/micropayment, for example by being incorporated into a vending machine and linked to a user's payment account.

In another example, the apparatus could be used in a ticketing application such as for payment on a public transport system.

In another application, the apparatus could be used for user validation, for example, by mounting an apparatus within a vehicle, the apparatus could be used to validate that the user is entitled to drive the vehicle.

The action control apparatus can also trigger other actions, for example the transmission of coupons, rewards or loyalty coupons to a user via the user's mobile device.

In an example, the iris detection can be one part of a security measure. The iris detection of an individual can be supported by other biometric devices—e.g. facial recognition. If additional security measures are required fingerprint or palm detection or an infrared reader could be added to the device.

In another example, a Licence Plate Recognition System can be added as an additional feature to support the iris recognition of the driver and when these two identifications are matched at a server and verified, the driver can then have access to an area or through a boom gate.

Another example can be to provide for validation to gain access to rental cars where an individual iris' is pre-registered to partly identify the individual. This can be linked to their driver's licence registration. The matching of these two identifications at a server results in a verification and will then enable the user to have access to a vehicle that is either been pre-booked or is accessed on the day from a kiosk terminal or user's phone which is linked to a payment wallet or credit card.

The concept device can be integrated into any kiosk terminal or can be used as a standalone apparatus for validation for access.

In the above description certain steps are described as being carried out by the apparatus. It will be appreciated that these steps will be carried out by software executed by one or more processors, for example using an appropriately configured computer server. It will be appreciated that such steps will often require a number of sub-steps to be carried out for the steps to be implemented electronically, for example due to hardware or programming limitations. For example, to carry out a step such as evaluating, determining or selecting, a processor may need to compute several values and compare those values.

The program code could be supplied in a number of ways, for example on a tangible computer readable storage medium, such as a disc or a memory device, e.g. an EEPROM, (for example, that could replace part of memory 103) or as a data signal (for example, by transmitting it from a server). Further, different parts of the program code can be executed by different devices, for example, in a client server relationship. In the present case, one configuration is that the approved iris data is stored centrally on a server of the apparatus. Persons skilled in the art will appreciate that program code provides a series of instructions executable by the processor.

Herein the term “processor” is used to refer generically to any device that can process instructions and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor, for example, an application specific integrated circuit (ASIC) or a field programmable gate array (FPGA).

It will be understood to persons skilled in the art of the invention that many modifications may be made without departing from the spirit and scope of the invention; in particular it will be apparent that certain features of embodiments of the invention can be employed to form further embodiments.

For example, alternative embodiments can be used to control entry of other types of entry and in even in the example of a car park, the entry may not be a boom gate but could be, for example, a roller door.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

What is claimed is:

1. An action control apparatus comprising:
an iris scanner comprising an image capture device mounted to a movement mechanism controllable to move the image capture device along at least one axis;
a movement controller arranged to monitor an area proximate the image capture device in order to detect at least one object associated with an expected position of an iris to be scanned, and upon detection of the at least one object, control the movement mechanism based on a position of the at least one object to move the image capture device along the at least one axis to a scanning position where the iris scanner can scan the iris;
an iris scanner controller arranged to control the iris scanner to obtain a scan of the iris when the iris scanner is in the scanning position; and
an action controller arranged to determine whether to cause an action to occur based on a comparison of the scan of the iris with a database containing data of one or more approved irises.

2. An action control apparatus as claimed in claim 1, wherein the action controller is associated with a car park and the action is to cause a car park barrier to open.

3. An action control apparatus as claimed in claim 2, wherein the object is a vehicle window.

4. An action control apparatus as claimed in claim 1, wherein the object is a head.

5. An action control apparatus as claimed in claim 1, wherein the object is a face.

6. An action control apparatus as claimed in claim 1, wherein the object is an eye.

7. An action control apparatus as claimed in claim 1, wherein the iris scanner is mounted to a movement mechanism for substantially vertical movement.

8. An action control apparatus as claimed in claim 1, wherein the iris scanner is mounted for movement along two or more axes.

9. An action control apparatus as claimed in claim 8, where movement is constrained within a defined region to prevent the iris scanner from contacting a vehicle.
